(19) United States
(12) Patent Application Publication
(10) Pub. No.: US 2025/0096231 A1
(43) Pub. Date: Mar. 20, 2025

(54) ELECTRODE, SECONDARY BATTERY, AND BATTERY PACK

(71) Applicant: KABUSHIKI KAISHA TOSHIBA, Tokyo (JP)

(72) Inventors: Tomoko SUGIZAKI, Kawasaki (JP); Norio TAKAMI, Yokohama (JP); Keigo HOSHINA, Yokohama (JP)

(73) Assignee: KABUSHIKI KAISHA TOSHIBA, Tokyo (JP)

(21) Appl. No.: 18/738,194

(22) Filed: Jun. 10, 2024

(30) Foreign Application Priority Data
Sep. 20, 2023 (JP) 2023-151906

(51) Int. Cl. H01M 4/134; H01M 4/02; H01M 4/38; H01M 4/62; H01M 10/0525; H01M 10/0568; H01M 10/42

(52) U.S. Cl. CPC H01M 4/134; H01M 4/382; H01M 4/628; H01M 10/0525; H01M 10/0568; H01M 10/4235; H01M 2004/027; H01M 2220/10; H01M 2220/20; H01M 2300/0025

(57) ABSTRACT

In general, according to one embodiment, an electrode includes an electrode layer and a film containing F, S, and N. The electrode layer includes at least one of a Li metal or a Li alloy. The film covers at least a part of a surface of the electrode layer. The electrode satisfies the following formula (1):

$$1.5 \leq {I}_{1} / {I}_{2} \qquad ( 1 )$$

where I₁ is an intensity of a first peak that appears in a range of 686 eV or more and 690 eV or less of an F1s spectrum obtained by X-ray photoelectron spectroscopy, and I₂ is an intensity of a second peak that appears in a range of 683 eV or more and 685 eV or less of the F1s spectrum.

### CROSS-REFERENCE TO RELATED APPLICATION(S)

This application is based upon and claims the benefit of priority from Japanese Patent Application No. 2023-151906, filed Sep. 20, 2023, the entire contents of which are incorporated herein by reference.

### FIELD

Embodiments described herein relate generally to an electrode, a secondary battery, a battery pack, a vehicle, and a stationary power supply.

### BACKGROUND

Batteries including metal Li as a negative electrode have attracted attention because such batteries enable a high energy density. In the meantime, ionic liquid electrolytes have been studied due to their non-volatility, incombustibility, and non-flammability. Ionic liquid electrolytes have a drawback in that the resistance is increased because an unstable film is generated on a negative electrode by a reductive decomposition at the negative electrode.

### BRIEF DESCRIPTION OF THE DRAWING(S)

FIG. 1 is a cross-sectional view schematically showing an example of a secondary battery according to an embodiment.

FIG. 2 is an enlarged cross-sectional view of part A of the secondary battery shown in FIG. 1.

FIG. 3 is a partially cutaway perspective view schematically showing another example of the secondary battery according to the embodiment.

FIG. 4 is an enlarged cross-sectional view of part B of the secondary battery shown in FIG. 3.

FIG. 5 is an exploded perspective view schematically showing an example of a battery pack according to the embodiment.

FIG. 6 is a block diagram showing an example of an electric circuit of the battery pack shown in FIG. 5.

FIG. 7 is a cross-sectional view schematically showing an example of a vehicle according to the embodiment.

FIG. 8 is a block diagram showing an example of a system including a stationary power supply according to the embodiment.

FIG. 9 is a diagram showing spectrums of electrodes obtained by X-ray photoelectron spectroscopy.

### DETAILED DESCRIPTION

According to one embodiment, an electrode is provided which includes an electrode layer including at least one of a Li metal or a Li alloy, and a film containing F, S, and N. The film containing F, S, and N covers at least a part of a surface of the electrode layer. The electrode satisfies the following formula (1):

$$1.5 \leq {I}_{1} / {I}_{2} \qquad ( 1 )$$

where I₁ is an intensity of a first peak that appears in a range of 686 eV or more and 690 eV or less of an F1s spectrum obtained by X-ray photoelectron spectroscopy, and I₂ is an intensity of a second peak that appears in a range of 683 eV or more and 685 eV or less of the F1s spectrum.

According to an embodiment, a secondary battery including a positive electrode, a negative electrode, and an electrolyte is provided. The negative electrode is the electrode according to the embodiment.

According to an embodiment, a battery pack including the secondary battery of the embodiment is provided.

According to an embodiment, a vehicle including the battery pack of the embodiment is provided. According to an embodiment, a stationary power supply including the battery pack of the embodiment is provided.

### First Embodiment

A first embodiment relates to an electrode. The electrode includes an electrode layer including at least one of a Li metal or a Li alloy, and a film containing F, S, and N. The electrode satisfies the following formula (1)

$$1.5 \leq {I}_{1} / {I}_{2} . \qquad ( 1 )$$

In the formula (1), I₁ is an intensity of a first peak that appears in a range of 686 eV or more and 690 eV or less of an F1s spectrum obtained by X-ray photoelectron spectroscopy (XPS). I₂ is an intensity of a second peak that appears in a range of 683 eV or more and 685 eV or less of the F1s spectrum obtained by XPS.

Since the aforementioned electrode can suppress an initial resistance and a resistance increase, the cycle life of the battery can be improved. Although the reason why the initial resistance and the resistance increase can be suppressed by the aforementioned electrode is not clear, it is assumed that the suppression is caused by the following mechanism:

The film containing F, S, and N (hereinafter referred to as an FSN-containing film) covers at least a part of a surface of the electrode layer. Thus, the FSN-containing film can constitute at least a part of the surface of the electrode. Therefore, it is considered that the F1s spectrum is an F1s spectrum of the FSN-containing film. The first peak derives from at least one of a C—F bond or a SO₂—F bond. The second peak derives from a Li—F bond. By setting the ratio I₁/I₂ of the intensity of the first peak to the intensity of the second peak to 1.5 or more, an abundance ratio of a component including at least one of the C—F bond or the SO₂—F bond in the FSN-containing film can be greater than that of a component including the Li—F bond. Accordingly, the resistance of the FSN containing film can be reduced, and the endurance (stability) of the FSN-containing film can be increased. As a result, the electrode of the embodiment can increase the charge-discharge cycle life of the secondary battery. The upper limit of the peak intensity ratio I₁/I₂ can be set to, for example, 15. By setting the peak intensity ratio I₁/I₂ to 15 or less, a sufficient reductive decomposition suppressing effect of an electrolyte (for example, a nonaqueous electrolyte such as an organic electrolyte) can be obtained. Therefore, generation of gas and an increase in resistance can be suppressed.

The component including at least one of the C—F bond or the SO₂—F bond (hereinafter referred to as a first bond) may be, for example, a group including the first bond, a functional group including the first bond, and a compound including the first bond. The component including the first bond may be an organic component.

The component including the Li—F bond (hereinafter referred to as a second bond) may be, for example, a group including the second bond, a functional group including the second bond, and a compound including the second bond. The component including the second bond may be an inorganic component. Specific examples of the component including the second bond include LiF. A LiF film is dense. Furthermore, the LiF film is resistant to decomposition and is highly durable. Therefore, by setting the peak intensity ratio I₁/I₂ to 1.5 or more, the resistance of the FSN-containing film can be lowered.

It is assumed that N in the FSN-containing film has a function of lowering the resistance of the FSN containing film. N in the FSN-containing film can be provided from, for example, [N(FSO₂)₂]⁻, [N(CF₃SO₂)₂]⁻, or the like.

The FSN-containing film can include at least one type of atom selected from the group consisting of Li, C, O, Si, and Cl. Each atom can be included in the FSN-containing film in the form of a single element, a compound, or the like.

The structure of the FSN-containing film is not particularly limited. Examples of the FSN-containing film include a film including a LiF film and an organic film containing F, S, and N. It is preferable that the LiF film be located on the electrode layer side, and the organic film containing F, S, and N be deposited on the LiF film.

It suffices that the FSN-containing film covers at least a part of the surface of the electrode layer. The surface of the electrode layer is a face that is in contact with or opposed to a separator or the other electrode. Examples of the surface of the electrode layer include a main surface of the electrode layer. The FSN-containing film may be in direct contact with the electrode layer. Alternatively, another layer or film may be interposed between the electrode layer and the FSN-containing film. Examples of another layer or film include an oxide film which may be formed on the surface of the electrode layer. An example of the oxide film may be a natural oxide film of lithium or the like.

The electrode layer may have a shape, such as a sheet shape, a belt shape, or the like.

The electrode layer includes at least one of a Li metal or a Li alloy. Examples of the lithium alloy include alloys such as Li—Al, Li—Si, Li—Zn, and Li—Mg. The Li—Mg alloy can suppress Li dendrite deposition. The molar content ratio of Mg in the Li—Mg alloy is preferably in the range of 0.05 or more and 0.15 or less. The Li metal can contain an element other than Li as an inevitable impurity.

The Li metal and the Li alloy each can preferably have a foil shape.

The electrode can include a current collector. The current collector can be formed of copper. The current collector can have a sheet shape, such as a foil shape. As an example of the current collector, a copper foil can be used.

The electrode can be obtained by, for example, fixing (for example, pressure bonding) a foil containing at least one of a Li metal or a Li alloy to a current collector, and thereafter performing a charge-discharge process on a battery precursor (for example, initially uncharged battery) produced by a method described later under conditions described later. The current collector can be omitted.

Details of an XPS analysis will now be described.

In a case where an electrode is assembled in a battery, first, the electrode is taken out from the battery by a method described below.

A secondary battery is disassembled in an argon atmosphere, and an electrode which is a target of measurement is taken out. The target of measurement is washed with a solvent comprising dimethyl carbonate in an argon atmosphere and vacuum-dried. Then, the measurement is performed as follows.

As an XPS apparatus, Quantera SXM produced by ULVAC-PHI, Inc. or an apparatus having a function equivalent thereto can be used. As an excitation X-ray source, a single-crystal spectral Al-Kα ray (1486.6 eV) is used. An X-ray output is set to 4 kW (13 kV×310 mA), a photoelectron detection angle is set to 45°, and an analysis area is set to about 4 mm×0.2 mm. Scanning is performed at 0.10 eV/step.

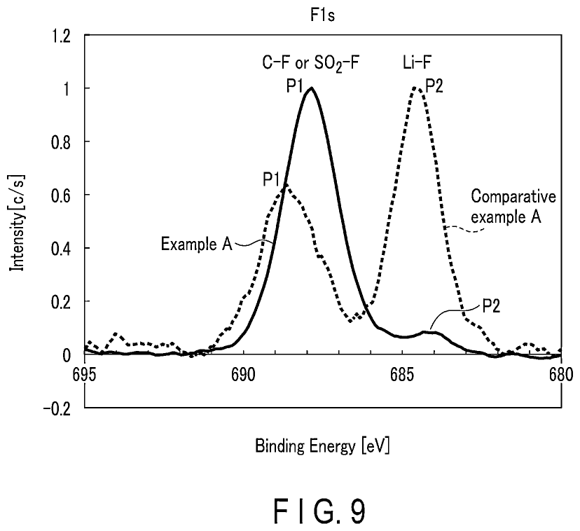

An example of the F1s spectrum obtained by XPS measured under the aforementioned conditions is shown in FIG. 9. In FIG. 9, the horizontal axis represents a binding energy (eV) and the vertical axis represents an intensity (c/s). An example of the spectrum of the electrode of the embodiment is indicated by a solid line as a spectrum of Example A. The spectrum of Comparative Example A is indicated by a dotted line. Backgrounds such as secondary electrons are removed by a Shirley method. Correction of the binding energy (eV) of the F1s spectrum on the horizontal axis is performed by adjusting the peak main of Li1s to 55.0 eV.

In the spectrum of Example A, a first peak P1 appears around 688 eV and a second peak P2 appears around 684 eV. The intensity I₁ at the first peak P1 is about 1 (c/s) and the intensity I₂ at the second peak P2 is about 0.1 (c/s). Thus, the peak intensity ratio I₁/I₂ is about 10, which satisfies the condition of 1.5 or more.

In the spectrum of Comparative Example A, a first peak P1 appears around 689 eV and a second peak P2 appears around 684 eV. The intensity I₁ at the first peak P1 is about 0.6 (c/s) and the intensity I₂ at the second peak P2 is about 1 (c/s). Thus, the peak intensity ratio I₁/I₂ is about 0.6, which is smaller than 1.5.

Furthermore, since the first peak P1 appears in the F1s spectrum obtained by XPS, it can be confirmed that S and F are contained in the film.

The fact that N is contained in the film can be confirmed by a peak appearing in an Nis spectrum obtained by XPS.

The electrode of the first embodiment described above includes an electrode layer containing at least one of a Li metal or a Li alloy, and includes a film containing F, S, and N. Furthermore, the electrode satisfies the following formula:

$$1.5 \leq {I}_{1} / {I}_{2} . \qquad ( 1 )$$

In the formula (1), I₁ is an intensity of a first peak that appears in a range of 686 eV or more and 690 eV or less of an F1s spectrum obtained by XPS. I₂ is an intensity of a second peak that appears in a range of 683 eV or more and 685 eV or less of the F1s spectrum obtained by XPS.

Since the aforementioned electrode can suppress an initial resistance and a resistance increase, the cycle life of a battery can be improved. In addition, since the electrode has a high energy density, it is also suitable for stationary power supplies and space uses.

### Second Embodiment

A second embodiment relates to a secondary battery. The secondary battery is, for example, a nonaqueous electrolyte secondary battery. Examples of the nonaqueous electrolyte secondary battery include a lithium secondary battery.

The secondary battery includes a positive electrode, a negative electrode, and an electrolyte. The electrode of the first embodiment is used as at least one of the positive electrode or the negative electrode. The secondary battery of the embodiment can include a separator and a container member in addition to the positive electrode, the negative electrode, and the electrolyte. The negative electrode, the positive electrode, and the separator may constitute an electrode group. The electrolyte can be held by the electrode group. The shape of the electrode group is not particularly limited, and may be, for example, a stacked type, a wound type, or the like.

An example of the secondary battery using the electrode of the first embodiment as the negative electrode is described below.

### (1) Positive Electrode

The positive electrode includes a positive electrode active material-containing layer containing a positive electrode active material, and a positive electrode current collector in contact with the positive electrode active material-containing layer. The positive electrode active material-containing layer may be integrated with the positive electrode current collector. The positive electrode active material-containing layer may be a porous body.

The positive electrode active material may be a compound that allows lithium ions to be inserted in and extracted from. Examples of the compound that allows lithium ions to be inserted in and extracted from include metal oxides and lithium metal oxides. Each oxide can provide a high-voltage secondary battery. Examples of the lithium metal oxide include lithium cobalt oxides (for example, Li_{y}CoO₂, 0<y≤1.1), lithium nickel cobalt manganese oxides (for example, Li_{y}NiₐCo_{b}Mn_{c}O₂, a+b+c=1, 0<a, 0<b, 0<c, 0<y≤1.1), lithium nickel cobalt aluminum oxides (for example, Li_{y}NiₐCo_{b}Al_{c}O₂, a+b+c=1, 0<a, 0<b, 0<c, 0<y≤1.1), lithium cobalt phosphate (for example, Li_{y}CoPO₄, 0<y≤1.1), lithium iron phosphate (for example, Li_{y}FePO₄, 0<y≤1.1), fluorinated lithium iron sulfate (for example, Li_{y}FeSO₄F, 0<y≤1.1), lithium iron manganese phosphate (for example, Li_{y}Mn₁₋ₐFeₐPO₄: 0<a≤0.5, 0<y≤1.1), lithium manganese oxides (for example, Li_{y}Mn₂O₄, 0<y≤1.1), lithium nickel manganese oxides (for example, Li_{y}Ni_{0.5}Mn_{1.5}O₄, 0<y≤1.1), lithium nickel manganese oxides having a spinel structure (for example, LiₓNiₐMn₂₋ₐO₄, 0.4≤a≤0.6, 0≤x≤1.1), and the like.

More preferred examples of the positive electrode active material are lithium nickel manganese oxides having a spinel structure, lithium cobalt oxides, lithium nickel cobalt manganese oxides, lithium nickel cobalt aluminum oxides, lithium cobalt phosphate, lithium manganese oxides, and the like. The aforementioned positive electrode active material can exhibit a high voltage of 4 V (vs. Li/Li⁺) or more.

One kind or two or more kinds of positive electrode active materials can be used.

The positive electrode active material-containing layer may contain a conductive agent. Examples of the conductive agent include carbon materials such as carbon nanofiber, acetylene black, and graphite. The carbon materials of the above kinds can improve the electronic network in the positive electrode. One kind or two or more kinds of conductive agents can be used. The ratio of the conductive agent in the positive electrode active material-containing layer (excluding the weight of the nonaqueous electrolyte) is preferably 5 wt % or more and 40 wt % or less.

The positive electrode active material-containing layer may contain a binder. Examples of the binder include polyethylene terephthalate, polysulfones, polyimides, cellulose, rubber, and the like. Binders of the above kinds are excellent in chemical stability to the nonaqueous electrolyte. The ratio of the binder in the positive electrode active material-containing layer (excluding the weight of the nonaqueous electrolyte) is preferably 1 wt % or more and 10 wt % or less.

The positive electrode active material-containing layer can contain lithium ion conductive solid electrolyte particles. Thus, the ion conductivity of the positive electrode can be enhanced. Examples of the lithium ion conductive solid electrolyte may include those similar to those described below in (2) Electrolyte.

As an example of the positive electrode current collector, a porous body, a mesh, or a foil of one or more metals selected from the group consisting of stainless steel, aluminum, and an aluminum alloy can be used. The thickness of the positive electrode current collector is preferably 10 μm or more and 20 μm or less. The porosity of the positive electrode current collector is preferably 30% or more and 98% or less, more preferably 50% or more and 60% or less.

### (2) Electrolyte

The electrolyte is, for example, a nonaqueous electrolyte. Examples of the nonaqueous electrolyte include an electrolyte including an ionic liquid. The ionic liquid may contain cations and anions.

Examples of the nonaqueous electrolyte include an ionic liquid containing a cation component including sulfonium cations and an anion component including anions including at least one of [N(FSO₂)₂]⁻ or [N(CF₃SO₂)₂]⁻. [N(FSO₂)₂]⁻ and [N(CF₃SO₂)₂]⁻ are respectively abbreviated as the FSI anion and the TFSI anion, respectively.

The FSI anions can enhance the intensities in both the first peak and the second peak. Therefore, the FSI anions can increase the component including the first bond (at least one of the C—F bond or the SO₂—F bond) and the component including the second bond (the Li—F bond) in the FSN-containing film. The FSI anion can produce the component including the first bond rather than the component including the second bond in the presence of both the TFSI anions and the sulfonium cations.

The anion component of the ionic liquid can contain the FSI anions and the TFSI anions. In this case, the molar ratio of the FSI anions to a total of the FSI anions and the TFSI anions can be set to a range of 0.3 or more and 0.6 or less. The component including the first bond in the FSN-containing film can be increased by setting the molar ratio to 0.3 or more. The component including the second bond in the FSN-containing film can be reduced by setting the molar ratio to 0.6 or less.

Examples of the sulfonium cation can include a trialkylsulfonium cation. The trialkylsulfonium cation has a skeleton represented by the following formula (2) and is paired with an anion. Examples of the anion include the FSI anion and the TFSI anion.

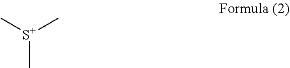

Examples of the trialkylsulfonium cation include a trimethylsulfonium cation (S(CH₃)₃⁺: abbreviated as S111), a triethylsulfonium cation (S(C₂H₅)₃⁺: abbreviated as S222), a diethylpropylsulfonium cation (S(C₂H₅)₂(C₃H₇)+: abbreviated as S223), a methylethylpropylsulfonium cation (S(CH₃)(C₂H₅)(C₃H₇)+: abbreviated as S123), and the like. A preferred example is a triethylsulfonium cation (S222). By the ionic liquid containing the cation of S222, the melting point of the ionic liquid is lowered, and the ion conductivity is increased. In addition, by the ionic liquid containing the cation of S222, the electrochemical window of the nonaqueous electrolyte is widened, so that a high voltage secondary battery can be operated. One kind or two or more kinds of trialkylsulfonium cations can be used.

The cation component of the ionic liquid can further contain a lithium ion. The lithium ion can be supplied from, for example, a lithium salt. As the lithium salt, LiN(FSO₂)₂ and LiN(CF₃SO₂)₂ are preferable. One kind or two or more kinds of lithium salts can be used. The amount of the lithium salt dissolved in the ionic liquid is preferably 0.3 mol/kg or more and 3 mol/kg or less. Within this range, the interface resistance of the negative electrode such as the metallic lithium can be reduced, so that improvement of large current characteristics, suppression of dendrite deposition, and improvement of cycle life performance can be achieved. LiN(FSO₂)₂ and LiN(CF₃SO₂)₂ are abbreviated as LiFSI and LiTFSI, respectively.

The nonaqueous electrolyte may contain an organic fluorine compound. Examples of the organic fluorine compound include a fluorinated ester, a fluorinated ether, and the like. Examples of the fluorinated ester include fluoroethylene carbonate (FEC), difluoroethylene carbonate (DFEC), 2,2,2-trifluoroethyl methyl carbonate (TFEMC), and the like. Examples of the fluorinated ether include 1,1,2,2-tetrafluoroethyl 2,2,2-trifluoroethyl ether (HFE) and the like.

Examples of other organic fluorine compounds include methyl 3,3,3-trifluoropropionate (FMP), 2,2,2-trifluoroethyl acetate (FEA), and the like. One kind or two or more kinds of organic fluorine compounds can be used.

The content of the organic fluorine compound in the nonaqueous electrolyte is set to, for example, 0.1 wt % or more and 10 wt % or less.

The nonaqueous electrolyte may contain particles of a lithium ion conductive solid electrolyte. Thus, the ion conductivity at a low temperature can be improved. The lithium ion conductive solid electrolyte preferably has a lithium ion conductivity at 25° C. of 1×10⁻⁴ S/cm or more, more preferably 1×10⁻³ S/cm or more.

Examples of the lithium ion conductive solid electrolyte include an oxide solid electrolyte having a garnet-type structure, a lithium phosphate solid electrolyte having a NASICON-type structure, and the like.

The oxide solid electrolyte having a garnet-type structure has advantages of high reduction resistance and a wide electrochemical window. Examples of the oxide solid electrolyte having a garnet-type structure and a lithium ion conductivity at 25° C. of 1×10⁻³ S/cm or more include La₅₊ₓAₓLa₃₋ₓM₂O₁₂ (A is one or more selected from the group consisting of Ca, Sr, and Ba, M is one or more selected from the group consisting of Nb and Ta, 0≤x≤0.5), Li₃M₂₋ₓL₂O₁₂ (M is one or more selected from the group consisting of Ta and Nb, L may include Zr, 0≤x≤0.5), Li₇₋₃ₓAlₓLa₃Zr₃O₁₂ (0<x≤0.5), and Li₇La₃Zr₂O₁₂. Li_{6.25}Al_{0.25}La₃Zr₃O₁₂ and Li₇La₃Zr₂O₁₂ each have high ion conductivity and stable electrochemical properties, and therefore can provide a secondary battery excellent in discharge performance and cycle life performance.

Examples of the lithium phosphate solid electrolyte having a NASICON-type structure and a lithium ion conductivity at 25° C. of 1×10⁻⁴ S/cm or more include a substance represented by LiM₂(PO₄)₃ (M is one or more selected from the group consisting of Si, Ti, Ge, Sr, Zr, Sn, Al, and Ca). A solid electrolyte represented by Li_{1+y}AlₓM₂₋ₓ(PO₄)₃ (M is one or more selected from the group consisting of Si, Ti, Ge, Sr, Zr, and Ca, 0≤x≤1, 0≤y≤1) is preferable. Li₁₊ₓAlₓGe₂₋ₓ(PO₄)₃ (0≤x≤0.5, 0≤y≤1), Li₁₊ₓAlₓZr₂₋ₓ(PO₄)₃ (0≤x≤0.5), and Li₁₊ₓAlₓTi₂₋ₓ(PO₄)₃ (0≤x≤0.5) are preferable because they have high ion conductivity and high electrochemical stability.

The solid electrolyte may contain an inevitable impurity other than those listed above. One kind or two or more kinds of solid electrolytes can be used.

The nonaqueous electrolyte is desirably in contact with the positive electrode and the negative electrode, or contained or held in the positive electrode, the negative electrode, and the separator. This makes it possible to smoothly produce a charge-discharge reaction.

The nonaqueous electrolyte is desirably in a liquid state or a gel state. The gel nonaqueous electrolyte is obtained by, for example, adding a polymer material and a gelling agent to an ionic liquid to form a gel.

A method for identifying the component of the nonaqueous electrolyte will now be described by using, as an example, a case where the nonaqueous electrolyte is contained in the secondary battery.

First, the secondary battery containing the nonaqueous electrolyte, which is a target of measurement, is discharged at 1 C until the battery voltage reaches 1.0 V. The discharged secondary battery is disassembled in a glove box in an inert atmosphere. Next, the nonaqueous electrolyte contained in the battery and the electrode group is extracted. In a case where the nonaqueous electrolyte can be taken out from the portion where the battery is opened, the nonaqueous electrolyte is sampled as it is. On the other hand, in a case where the nonaqueous electrolyte which is the target of measurement is held in the electrode group, the electrode group is further disassembled, and for example, a separator impregnated with the nonaqueous electrolyte is taken out. The nonaqueous electrolyte impregnated in the separator can be extracted by using, for example, a centrifuge or the like. Thus, sampling of the nonaqueous electrolyte can be performed. In a case where the amount of the nonaqueous electrolyte contained in the secondary battery is small, the nonaqueous electrolyte can be extracted by immersing the electrode and the separator in an acetonitrile solution. The extraction amount can be calculated by measuring the weight of the acetonitrile solution before and after extraction.

The sample of the nonaqueous electrolyte thus obtained is subjected to, for example, a gas chromatography mass spectrometry apparatus (GC-MS) or nuclear magnetic resonance spectroscopy (NMR) to perform a composition analysis. In the analysis, first, components contained in the nonaqueous electrolyte are identified. Next, a calibration curve of each component is prepared. In a case where a plurality of kinds of components are included, a calibration curve for each component is created. The composition of the nonaqueous electrolyte can be determined by comparing the created calibration curve with the peak intensity or area in the result obtained by measuring the sample of the nonaqueous electrolyte.

### (3) Separator

The separator can be provided on at least one surface of the positive electrode, on at least one surface of the negative electrode, or between the positive electrode and the negative electrode. The separator may be in contact with the positive electrode, the negative electrode, or the positive and negative electrodes, but may be integrated with the positive electrode, the negative electrode, or the positive and negative electrodes.

Examples of the separator include a nonwoven fabric, a porous membrane, and a lithium ion conductive solid electrolyte membrane. Examples of the material for forming the nonwoven fabric include polymer fibers such as cellulose, polyacrylonitrile (PAN), and polyimides, inorganic fibers such as alumina and silica, and the like. Examples of the material for forming the porous membrane include polyethylene (PE), polypropylene (PP), and polyimides. In a case where the viscosity of the ionic liquid is high, the porosity of the separator can be set to 60% or more and 80% or less. The thickness of the separator can be 5 μm or more and 50 μm or less.

At least one main surface of the separator or a positive electrode surface and/or a negative electrode surface in contact with the separator is preferably coated with inorganic oxide particles. Examples of the inorganic oxide particles include alumina particles, titania particles, and lithium conductive solid electrolyte particles. One kind or two or more kinds of inorganic oxide particles can be used. Examples of the lithium conductive solid electrolyte may include those similar to those described in (2) Electrolyte.

One kind or two or more kinds of separators can be used. For example, a separator including a solid electrolyte membrane having lithium ion conductivity and a separator including a nonwoven fabric or a porous membrane can be used in an overlapping manner.

### (4) Container Member

The secondary battery may include a container member. The container member includes a container having an opening, and a lid attached to the opening of the container. The lid may be a member separate from or integrated with the container. The container member only needs to be capable of housing the positive electrode, the negative electrode, the separator, and the nonaqueous electrolyte, and is not limited to the structure shown in the drawings. A container member having a shape corresponding to a prismatic, thin, cylindrical, or coin-shaped battery may be used.

Materials constituting the container member include a metal, a laminate film, etc.

Examples of the metal include iron, stainless steel, aluminum, nickel, and the like. In a case where a metal can is used for the container, the plate thickness of the container is desirably set to 0.5 mm or less, and a more preferred range is 0.3 mm or less.

Examples of the laminate film include a multilayer film in which aluminum foil or stainless steel foil is covered with a resin film, and the like. As the resin, polymers such as polypropylene (PP), polyethylene (PE), nylon, and polyethylene terephthalate (PET) can be used. The thickness of the laminate film is preferably set to 0.2 mm or less.

### <Producing Method>

The secondary batteries according to the embodiment can be produced, for example, in the following manner.

A method for producing the secondary battery includes: preparing, as a negative electrode, an electrode on which no FSN-containing film is formed; preparing a positive electrode; preparing an electrolyte; housing the negative electrode and the positive electrode in a container member; injecting the electrolyte into the container member; sealing the container member to obtain a battery precursor; and performing a charge-discharge process a plurality of times on the battery precursor.

The electrode on which no FSN-containing film is formed is produced by fixing (for example, pressure bonding) a foil containing at least one of a Li metal or a Li alloy to a current collector, as described above. Alternatively, a foil containing at least one of a Li metal or a Li alloy may be used as the electrode.

The positive electrode is produced, for example, by the following method. A positive electrode active material, a conductive agent, and a binder are suspended in a solvent to prepare a slurry. The slurry is applied to one or both surfaces of the current collector. The applied slurry is dried to obtain a layer stack of an active material containing layer and the current collector. Then, the layer stack is pressed. The positive electrode is thus produced. Alternatively, the positive electrode may be produced by the following method. First, a positive electrode active material, a conductive agent, and a binder are mixed to obtain a mixture. Then, the mixture is shaped into pellets. The pellets are disposed on the current collector, so that the positive electrode is obtained.

As the electrolyte, a nonaqueous electrolyte containing an ionic liquid is prepared, the ionic liquid containing a cation component which includes sulfonium cations and an anion component which includes at least one of FSI anions or TFSI anions.

The charge-discharge process of a plurality of times is a process of performing charge and discharge a plurality of times at a room temperature (for example, 25° C.) or higher and 45° C. or lower at a current rate of 0.2 C or more and 1 C or less. 1 C is a current value for discharging a nominal capacity of a secondary battery in 1 hour. By setting the temperature in the charge-discharge process within the aforementioned range, the viscosity of the nonaqueous electrolyte containing the ionic liquid can be kept low, so that the resistance can be small. Therefore, the deposition of Li dendrite can be suppressed. By setting the current rate in the charge-discharge process within the aforementioned range, the reaction on the electrode surface progresses uniformly, so that the FSN-containing film can be uniformly formed.

By repeating the charge-discharge process a plurality of times at the temperature and the current rate as described above, the FSN-containing film can be uniformly formed on the electrode surface. The number of times of charge and discharge can be set to, for example, 2 or more and 10 or less. The voltage range of the charge-discharge process may be the same from the first time to the last time, or may be varied.

A pause may be provided between a charge-discharge process and the next charge-discharge process. As a result, the state inside the battery (inside the container member) can be stabilized. The pause can be set to 10 minutes or longer and 1 hour or shorter.

Before performing the charge-discharge process a plurality of times, the battery precursor may be subjected to a preservation (aging) treatment.

According to the method described above, since the uniformity of the FSN-containing film can be improved while Li dendrite deposition is avoided, the secondary battery including the electrode of the embodiment can be produced.

Next, a secondary battery according to the embodiment will be described with reference to the drawings.

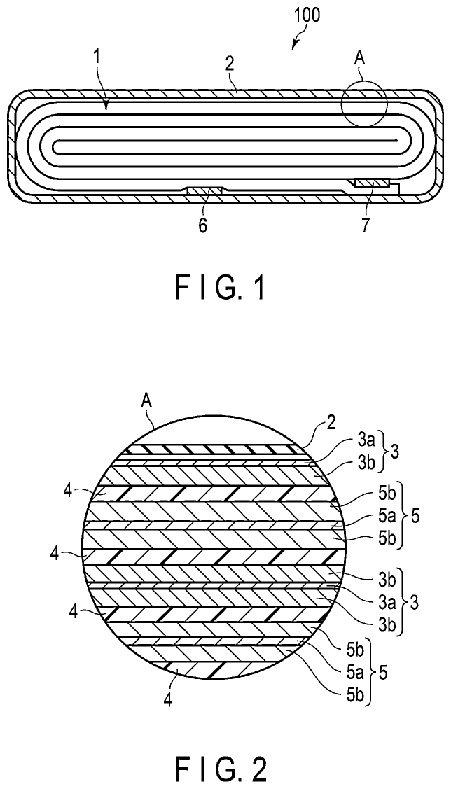

FIG. 1 is a cross-sectional view schematically showing an example of a secondary battery according to the embodiment. FIG. 2 is an enlarged cross-sectional view of part A of the secondary battery shown in FIG. 1.

A secondary battery 100 shown in FIGS. 1 and 2 includes a bag-shaped container member 2 shown in FIGS. 1 and 2, an electrode group 1 shown in FIG. 1, and a nonaqueous electrolyte (not shown). The electrode group 1 and the nonaqueous electrolyte are housed in the bag-shaped container member 2. The nonaqueous electrolyte (not shown) is held in the electrode group 1.

The bag-shaped container member 2 is formed of a laminate film including two resin layers and a metal layer interposed therebetween.

As shown in FIG. 1, the electrode group 1 is a flat wound electrode group. As shown in FIG. 2, the flat wound electrode group 1 includes a negative electrode 3, a separator 4, and a positive electrode 5. The separator 4 is interposed between the negative electrode 3 and the positive electrode 5.

The negative electrode 3 includes a negative electrode current collector 3a and a negative electrode layer 3b. In the portion of the negative electrode 3 located in the outermost shell of the wound electrode group 1, as shown in FIG. 2, the negative electrode layer 3b is formed only on the inner surface side of the negative electrode current collector 3a. In the other part of the negative electrode 3, the negative electrode layer 3b is formed on both surfaces of the negative electrode current collector 3a.

The positive electrode 5 includes a positive electrode current collector 5a and positive electrode mixture layers (positive electrode active material-containing layers) 5b formed on both surfaces of the positive electrode current collector 5a.

As shown in FIG. 1, a negative electrode terminal 6 and a positive electrode terminal 7 are located near the outer peripheral end of the wound electrode group 1. The negative electrode terminal 6 is electrically connected to a portion located at the outermost shell of the negative electrode current collector 3a. The positive electrode terminal 7 is electrically connected to a portion located at the outermost shell of the positive electrode current collector 5a. The negative electrode terminal 6 and the positive electrode terminal 7 extend to the outside from the opening of the bag-shaped container member 2. A thermoplastic resin layer is provided on the inner surface of the bag-shaped container member 2, and the opening is closed by thermally fusing the thermoplastic resin layer.

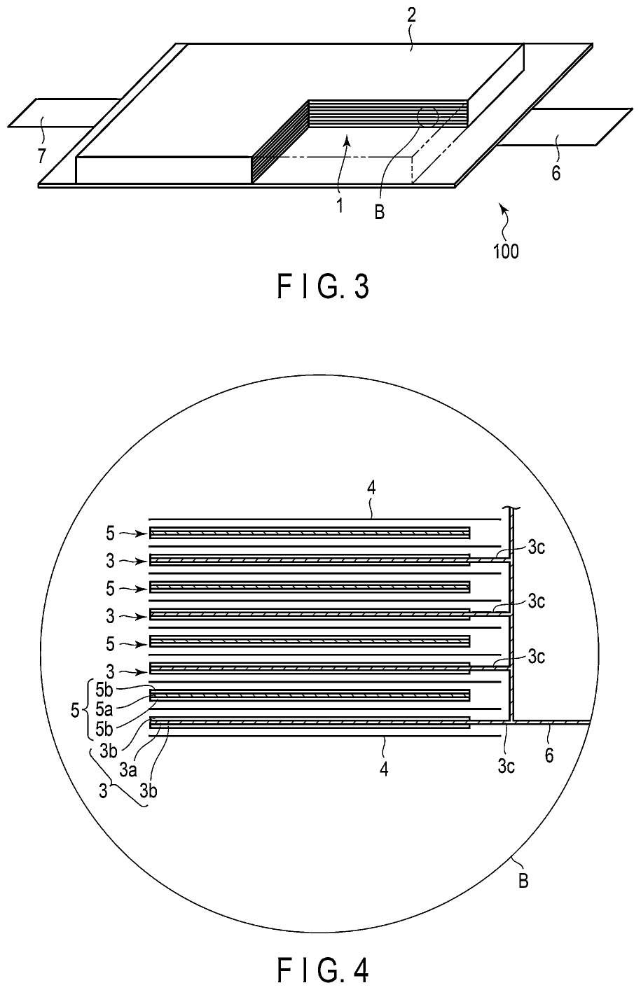

The secondary battery according to the embodiment is not limited to the secondary battery of the configuration shown in FIGS. 1 and 2, and may be, for example, a battery of the configuration shown in FIGS. 3 and 4.

FIG. 3 is a partially cutaway perspective view schematically showing another example of the secondary battery according to the embodiment. FIG. 4 is an enlarged cross-sectional view of part B of the secondary battery shown in FIG. 3.

A secondary battery 100 shown in FIGS. 3 and 4 includes an electrode group 1 shown in FIGS. 3 and 4, a container member 2 shown in FIG. 3, and a nonaqueous electrolyte (not shown). The electrode group 1 and the nonaqueous electrolyte are housed in the container member 2. The nonaqueous electrolyte is held in the electrode group 1.

The container member 2 is formed of a laminate film including two resin layers and a metal layer interposed therebetween.

As shown in FIG. 4, the electrode group 1 is a stacked electrode group. The stacked electrode group 1 has a structure in which the negative electrode 3 and the positive electrode 5 are alternately stacked with the separator 4 interposed therebetween.

The electrode group 1 includes a plurality of negative electrodes 3. Each of the plurality of negative electrodes 3 includes a negative electrode current collector 3a and a negative electrode layer 3b supported on both surfaces of the negative electrode current collector 3a. The electrode group 1 includes a plurality of positive electrodes 5. Each of the plurality of positive electrodes 5 includes a positive electrode current collector 5a and a positive electrode mixture layer 5b supported on both surfaces of the positive electrode current collector 5a.

The negative electrode current collector 3a of each negative electrode 3 includes, on one side thereof, a portion 3c where the negative electrode layer 3b is not supported on any surface. The portion 3c serves as a negative electrode tab. As shown in FIG. 4, the portion 3c serving as the negative electrode tab does not overlap with the positive electrode 5. The plurality of negative electrode tabs (portions 3c) are electrically connected to a belt-shaped negative electrode terminal 6. The tip of the belt-shaped negative electrode terminal 6 is drawn out of the container member 2.

Although not shown, the positive electrode current collector 5a of each positive electrode 5 includes, on one side thereof, a portion where the positive electrode mixture layer 5b is not supported on any surface. This portion serves as a positive electrode tab. The positive electrode tab does not overlap with the negative electrode 3. The positive electrode tab is located on the opposite side of the electrode group 1 with respect to the negative electrode tab (portion 3c). The positive electrode tab is electrically connected to the belt-shaped positive electrode terminal 7. The tip of the belt-shaped positive electrode terminal 7 is located on the opposite side to the negative electrode terminal 6, and is drawn out of the container member 2.

Since the secondary battery according to the embodiment described above includes the electrode of the first embodiment, a secondary battery in which the initial resistance is low, the resistance increase is suppressed, and the charge-discharge cycle performance is excellent can be provided.

### Third Embodiment

According to a third embodiment, a battery pack is provided. The battery pack includes the secondary battery according to the second embodiment. The battery pack may include one secondary battery according to the second embodiment or include a battery module constituted by a plurality of secondary batteries according to the second embodiment.

The battery pack according to the embodiment may further include a protective circuit. The protective circuit has a function to control the charge and discharge of the secondary battery. Alternatively, a circuit included in equipment where the battery pack serves as a power source (for example, electronic devices, automobiles, and the like) may be used as the protective circuit of the battery pack.

The battery pack according to the embodiment may further include an external power distribution terminal. The external power distribution terminal is configured to externally output current from the secondary battery, and/or to input external current into the secondary battery. In other words, when the battery pack is used as a power source, the current is supplied to the outside through the external power distribution terminal. When the battery pack is charged, the charging current (including regenerative energy from the motive force of automobiles and the like) is supplied to the battery pack via the external power distribution terminal.

Next, an example of the battery pack according to the embodiment will be described with reference to the drawings.

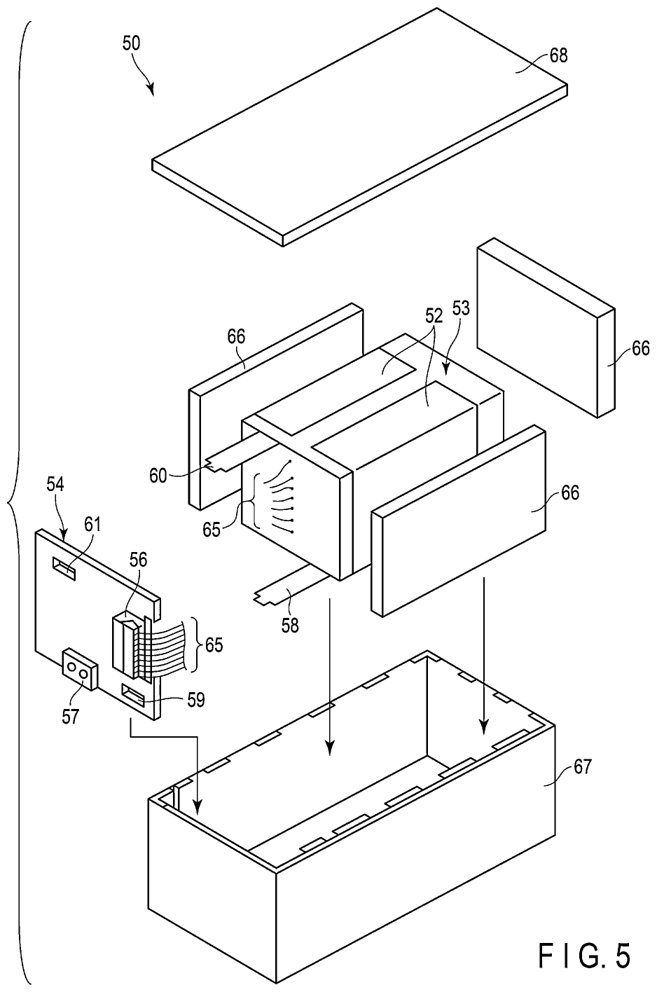

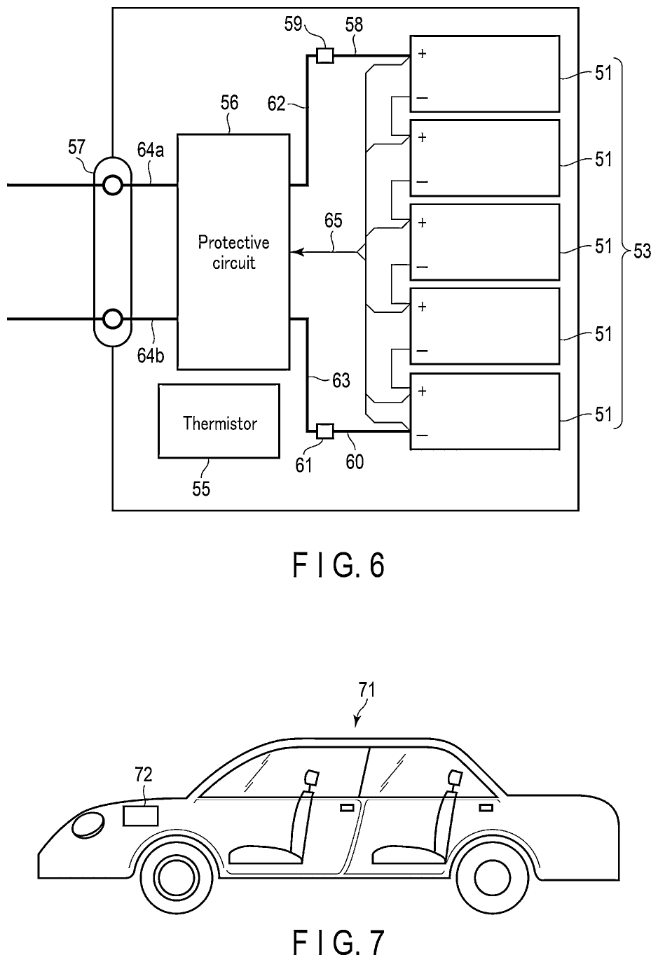

FIG. 5 is an exploded perspective view schematically showing an example of the battery pack according to the embodiment that is disassembled for each part. FIG. 6 is a block diagram showing an example of an electric circuit of the battery pack shown in FIG. 5.

FIGS. 5 and 6 show an example of a battery pack 50. The battery pack 50 shown in FIGS. 5 and 6 includes multiple secondary batteries according to the embodiment. Multiple secondary batteries 51 are stacked so that the negative electrode terminals and the positive electrode terminals are aligned in the same direction on a plane and are fastened with an adhesive tape 52 to constitute a battery module 53. These secondary batteries 51 are electrically connected to each other in series as shown in FIG. 6.

A printed wiring board 54 is arranged to face the plane where the negative electrode terminals and the positive electrode terminals of the secondary battery 51 are disposed. A thermistor 55, a protective circuit 56, and an external power distribution terminal 57 to an external device are mounted on the printed wiring board 54 as shown in FIG. 6. An insulating plate (not shown) is attached to the plane of the printed wiring board 54 that faces the battery module 53 to avoid unnecessary connection with the wires of the battery module 53.

A positive electrode-side lead 58 is connected to the positive electrode terminal positioned at the bottom layer of the battery module 53, and the distal end of the lead 58 is inserted into a positive electrode-side connector 59 of the printed wiring board 54 so as to be electrically connected. A negative electrode-side lead 60 is connected to the negative electrode terminal positioned at the top layer of the battery module 53, and the distal end of the lead 60 is inserted into a negative electrode-side connector 61 of the printed wiring board 54 so as to be electrically connected. The connectors 59 and 61 are connected to the protective circuit 56 through wires 62 and 63 formed on the printed wiring board 54.

The thermistor 55 detects the temperature of the secondary batteries 51, and the detection signal is sent to the protective circuit 56. The protective circuit 56 can shut down a plus-side wire 64a and a minus-side wire 64b between the protective circuit 56 and the external power distribution terminal 57 to an external device under a predetermined condition. An example of the predetermined condition is a state in which the temperature detected by the thermistor 55 reaches a predetermined level or higher. Another example of the predetermined condition is a state in which overcharge, overdischarge, over-current, and the like of the secondary batteries 51 is detected. The detection of the overcharge and the like is performed either on individual secondary batteries 51 or the secondary batteries 51 in their entirety. When each individual secondary battery 51 is to be detected, the battery voltage may be detected, or a positive electrode potential or a negative electrode potential may be detected. In the latter case, a lithium electrode to be used as a reference electrode is inserted into each of the secondary batteries 51. In the case of the battery pack shown in FIGS. 5 and 6, wires 65 for voltage detection are connected to each of the secondary batteries 51, and detection signals are sent to the protective circuit 56 through the wires 65.

Protective sheets 66 made of rubber or resin are arranged on three side surfaces of the battery module 53, the excluded side surface being the side surface from which the positive electrode terminal and the negative electrode terminal protrude.

The battery module 53 is housed in a housing container 67 together with each of the protective sheets 66 and the printed wiring board 54. That is, the protective sheets 66 are arranged on both inner side surfaces in the long-side direction and an inner side surface in the short-side direction of the housing container 67, and the printed wiring board 54 is disposed on the opposite inner side surface in the short-side direction. The battery module 53 is positioned in a space surrounded by the protective sheets 66 and the printed wiring board 54. A lid 68 is attached to the upper surface of the housing container 67.

In order to fix the battery module 53, a heat-shrinkable tape may be used in place of the adhesive tape 52. In this case, the battery module is bound by placing the protective sheets on both sides of the battery module, winding the heat-shrinkable tape around the battery module, and then thermally shrinking the heat-shrinkable tape.

FIGS. 5 and 6 show the configuration in which the secondary batteries 51 are connected in series; however, the secondary batteries may be connected in parallel to increase the battery capacity. Alternatively, in-series and in-parallel connections may be combined. Assembled battery packs can be further connected in series or in parallel.

The battery pack shown in FIGS. 5 and 6 includes a single battery module; however, the battery pack according to the embodiment may include a plurality of battery modules. The battery modules are electrically connected in series, in parallel, or in a combination of in-series and in-parallel connections.

The aspect of the battery pack can be appropriately changed depending on the applications. The battery pack according to the present embodiment is suitably used in applications where excellent cycle performance is demanded during extraction of a large current. More specifically, the battery pack is used as a power supply for a digital camera, a battery for a vehicle such as a two- to four-wheeled hybrid electric automobile, a two- to four-wheeled electric automobile, an electric assist bicycle, or a railway vehicle (for example, an electric train), or a stationary battery. In particular, the battery pack is suitably used as a large-sized storage battery for a stationary power storage system or an in-vehicle battery for vehicles.

The battery pack according to the embodiment includes the secondary battery according to the embodiment. Therefore, the battery pack according to the embodiment is excellent in charge-discharge cycle performance.

### Fourth Embodiment

According to a fourth embodiment, a vehicle is provided. The vehicle includes the battery pack according to the embodiment.

In the vehicle according to the embodiment, the battery pack is configured, for example, to recover regenerative energy from the motive force of the vehicle. The vehicle may include a mechanism configured to convert kinetic vehicular energy into regenerative energy.

Examples of the vehicle include a two- to four-wheeled hybrid electric automobile, a two- to four-wheeled electric automobile, an electric assist bicycle, and a railway vehicle.

The installation position of the battery pack in the vehicle is not particularly limited. For example, when installing the battery pack in an automobile, the battery pack can be installed in the engine compartment of the vehicle, in a rear part of the vehicle body, or under seats.

The vehicle may include a plurality of battery packs. In this case, the battery packs may be electrically connected in series, electrically connected in parallel, or electrically connected in a combination of in-series and in-parallel connections.

Next, an example of the vehicle according to the embodiment will be described with reference to the drawings.

FIG. 7 is a cross-sectional view schematically showing an example of the vehicle according to the embodiment.

A vehicle 71 shown in FIG. 7 includes a vehicle body and a battery pack 72 according to the embodiment. In the example shown in FIG. 7, the vehicle 71 is a four-wheeled automobile.

The vehicle 71 may include a plurality of battery packs 72. In this case, the battery packs 72 may be connected in series, in parallel, or in a combination of in-series and in-parallel connections.

In FIG. 7, the battery pack 72 is installed in an engine compartment located in a front portion of the vehicle body. As described above, the battery pack 72 may be installed in a rear portion of the vehicle body, or under seats. The battery pack 72 may be used as a power source of the vehicle. In addition, the battery pack 72 can recover regenerative energy from the motive force from the vehicle.

The vehicle according to the embodiment includes the battery pack according to the embodiment. Thus, the present embodiment can provide a vehicle that includes a battery pack excellent in charge-discharge cycle performance.

### Fifth Embodiment

According to a fifth embodiment, a stationary power supply is provided. The stationary power supply includes the battery pack according to the embodiment. The stationary power supply may include the secondary battery or battery module according to the embodiment, instead of the battery pack according to the embodiment.

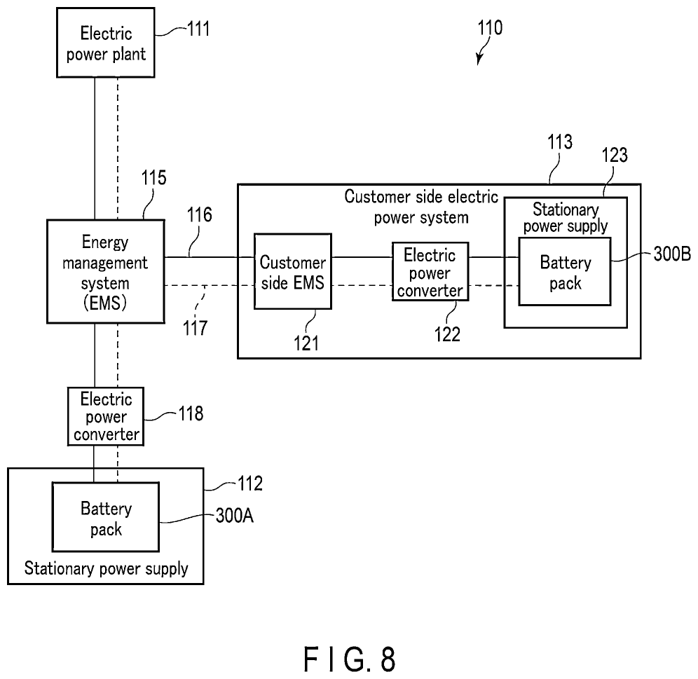

FIG. 8 is a block diagram showing an example of a system including a stationary power supply according to the embodiment. FIG. 8 is a diagram showing an application example to stationary power supplies 112 and 123 as an example of using battery packs 300A and 300B according to the embodiment. In one example shown in FIG. 8, a system 110 is shown in which the stationary power supplies 112 and 123 are used. The system 110 includes an electric power plant 111, the stationary power supply 112, a customer side electric power system 113, and an energy management system (EMS) 115. Also, an electric power network 116 and a communication network 117 are formed in the system 110, and the electric power plant 111, the stationary power supply 112, the customer side electric power system 113, and the EMS 115 are connected via the electric power network 116 and the communication network 117. The EMS 115 performs control operations to stabilize the entire system 110 by utilizing the electric power network 116 and the communication network 117.

The electric power plant 111 generates a large amount of electric power from fuel sources such as thermal power or nuclear power. Electric power is supplied from the electric power plant 111 through the electric power network 116 and the like. In addition, the battery pack 300A is installed in the stationary power supply 112. The battery pack 300A can store electric power and the like supplied from the electric power plant 111. In addition, the stationary power supply 112 can supply the electric power stored in the battery pack 300A through the electric power network 116 and the like. The system 110 is provided with an electric power converter 118. The electric power converter 118 includes a converter, an inverter, a transformer, and the like. Thus, the electric power converter 118 can perform conversion between direct current and alternate current, conversion between alternate currents of frequencies different from each other, voltage transformation (step-up and step-down), and the like. Therefore, the electric power converter 118 can convert electric power from the electric power plant 111 into electric power that can be stored in the battery pack 300A.

The customer side electric power system 113 includes an electric power system for factories, an electric power system for buildings, an electric power system for home use, and the like. The customer side electric power system 113 includes a customer side EMS 121, an electric power converter 122, and the stationary power supply 123. The battery pack 300B is installed in the stationary power supply 123. The customer side EMS 121 performs control operations to stabilize the customer side electric power system 113.

Electric power from the electric power plant 111 and electric power from the battery pack 300A are supplied to the customer side electric power system 113 through the electric power network 116. The battery pack 300B can store electric power supplied to the customer side electric power system 113. Similarly to the electric power converter 118, the electric power converter 122 includes a converter, an inverter, a transformer, and the like. Thus, the electric power converter 122 can perform conversion between direct current and alternate current, conversion between alternate currents of frequencies different from each other, voltage transformation (step-up and step-down), and the like. Therefore, the electric power converter 122 can convert electric power supplied to the customer side electric power system 113 into electric power that can be stored in the battery pack 300B.

The electric power stored in the battery pack 300B can be used, for example, for charging a vehicle such as an electric automobile. Also, the system 110 may be provided with a natural energy source. In such a case, the natural energy source generates electric power through natural energy such as wind power and solar light. In addition to the electric power plant 111, electric power is also supplied from the natural energy source through the electric power network 116.

The stationary power supply according to the embodiment includes the battery pack according to the embodiment. Thus, the present embodiment can provide a stationary power supply that includes a battery pack excellent in charge-discharge cycle performance.

### EXAMPLES

Hereinafter, examples of the present invention will be described in detail with reference to the drawings; however, the present invention is not limited to the Examples described below.

### Example 1

As a positive electrode active material, a lithium nickel cobalt manganese oxide (LiNi_{0.5}Co_{0.3}Mn_{0.2}O₂) having an average particle size of 3 μm was used. The positive electrode active material was blended with 2 wt % of acetylene black and 6 wt % of graphite powder as the conductive agents and 3 wt % of PVdF as a binder, and the blend was dispersed in a N-methylpyrrolidone (NMP) solvent to prepare a slurry. The content of each component in the slurry is a value when it is assumed that the positive electrode active material-containing layer accounts for 100 wt %. The slurry was applied to a current collector formed of aluminum foil having a thickness of 10 μm, and drying and pressing were performed; thus, a positive electrode (the density of the positive electrode active material-containing layer: 3.2 g/cm³) was produced.

A negative electrode was produced by pressure-bonding lithium metal foil having a thickness of 20 μm to copper current collector foil having a thickness of 6 μm.

As a nonaqueous electrolyte, an ionic liquid described below was prepared. A triethylsulfonium salt represented by S222TFSI and a lithium salt represented by LiFSI were mixed and adjusted so as to have molar fractions of 1:1; thus, an ionic liquid was prepared. The molar ratio of FSI anions to a total of TFSI anions and FSI anions was 0.5.

As a separator, a polyimide porous separator of 30 μm was prepared.

The positive electrode and the negative electrode were alternately stacked such that the separator was positioned therebetween; thus, an electrode group was fabricated. This electrode group was housed in a container formed of an aluminum-containing laminate film having a thickness of 0.1 mm; thus, a battery precursor of a secondary battery having the structure shown in FIG. 1 was produced. The secondary battery had a size of 7 mm×40 mm×60 mm. The secondary battery had a capacity of 2 Ah, an average voltage of 3.6 V, and a weight of 35 g.

The battery precursor of Example 1 was charged with a constant current of 0.2 C (0.4 A) to 4.2 V and then discharged with 0.2 C (0.4 A) to 3.0 V repeatedly 5 times at 45° C., thereby producing a secondary battery.

### Examples 2-10

A secondary battery was produced in a similar manner to that in Example 1 except that the molar ratio of FSI anions to the ionic liquid, the charge-discharge temperature, the charge-discharge rate, and the number of times of charge and discharge were set as shown in Table 1 below.

### Example 11

The battery precursor assembled in the same manner as in Example 1 was charged with a constant current of 0.2 C (0.4 A) to 4.2 V and then discharged with 0.2 C (0.4 A) to 2.8 V repeatedly 5 times at 45° C., thereby producing a secondary battery.

### Example 12

A secondary battery was produced in a similar manner to that in Example 1 except that the molar ratio of FSI anions to the ionic liquid, the charge-discharge temperature, the charge-discharge rate, and the number of times of charge and discharge were set as shown in Table 1 below.

### Comparative Examples 1-3 and 5

A secondary battery was produced in a similar manner to that in Example 1 except that the molar ratio of FSI anions to the ionic liquid, the charge-discharge temperature, the charge-discharge rate, and the number of times of charge and discharge were set as shown in Table 1 below.

### Comparative Example 4

A battery precursor assembled in the same manner as in Example 1 was used as a secondary battery without performing charge and discharge.

A charge-and-discharge cycle in which each secondary battery was charged with a constant current of 0.4 A to 4.2 V at 25° C. and then discharged with 0.4 A to 3.0 V was repeated, and the number of cycles at which the capacity retention ratio reached 80% was determined as the cycle life count. Assuming that the cycle life count of Example 1 is 100, the cycle life counts of the other Examples and Comparative Examples are indicated in Table 1.

Regarding the electrodes of Examples and Comparative Examples, the presence of a film containing F, S. and N on the surface of the electrode layer was confirmed by the aforementioned method. Further, the peak intensity ratio I₁/I₂ was measured by the aforementioned method, and the results of the measurement are indicated in Table 1.

TABLE 1

| | Molar | | Charge- | Number of times | Voltage range | Peak | Charge- |
|---|---|---|---|---|---|---|---|
| | ratio of | Charge-discharge | discharge | of | of charge and | intensity | discharge |
| | FSI anions | temperature (° C.) | rate (C) | charge/discharge | discharge (V) | ratio I₁/I₂ | cycle life |
| Ex. 1 | 0.5 | 45 | 0.2 | 5 | 3.0-4.2 V | 12.5 | 100 |
| Ex. 2 | 0.5 | 35 | 0.2 | 5 | 3.0-4.2 V | 9.7 | 96 |
| Ex. 3 | 0.5 | 25 | 0.2 | 5 | 3.0-4.2 V | 6.4 | 89 |
| Ex. 4 | 0.5 | 45 | 0.5 | 5 | 3.0-4.2 V | 7.7 | 92 |
| Ex. 5 | 0.5 | 45 | 1 | 5 | 3.0-4.2 V | 7.1 | 88 |
| Ex. 6 | 0.5 | 45 | 0.1 | 5 | 3.0-4.2 V | 13.0 | 103 |
| Ex. 7 | 0.5 | 45 | 0.2 | 3 | 3.0-4.2 V | 2.1 | 89 |
| Ex. 8 | 0.5 | 45 | 0.2 | 10 | 3.0-4.2 V | 12.8 | 97 |
| Ex. 9 | 0.3 | 45 | 0.2 | 5 | 3.0-4.2 V | 1.6 | 85 |
| Ex. 10 | 0.6 | 45 | 0.2 | 5 | 3.0-4.2 V | 12.2 | 86 |
| Ex. 11 | 0.5 | 45 | 0.2 | 5 | 2.8-4.2 V | 5.4 | 87 |
| Ex. 12 | 0.02 | 45 | 0.2 | 5 | 3.0-4.2 V | 16.7 | 68 |
| Compar. | 0.5 | 60 | 0.2 | 5 | 3.0-4.2 V | 0.7 | 51 |
| ex. 1 | | | | | | | |
| Compar. | 0.5 | 45 | 5 | 5 | 3.0-4.2 V | 0.4 | 30 |
| ex. 2 | | | | | | | |
| Compar. | 0.5 | 45 | 0.2 | 1 | 3.0-4.2 V | 1.2 | 47 |
| ex. 3 | | | | | | | |
| Compar. | 0.5 | — | — | — | — | 0.3 | 23 |
| ex. 4 | | | | | | | |
| Compar. | 0.1 | 45 | 0.2 | 5 | 3.0-4.2 V | 0.2 | 28 |
| ex. 5 | | | | | | | |

As evident from Table 1, the secondary batteries of Examples 1 to 12, in which the peak intensity ratio I₁/I₂ satisfies the condition of 1.5 or more, have a longer charge-discharge cycle life as compared to the secondary batteries of Comparative Examples 1 to 5, in which the peak intensity ratio I₁/I₂ is smaller than 1.5.

In Comparative Example 1 in which the charge-discharge temperature is comparatively high, Comparative Example 2 in which the charge-discharge current rate is comparatively high, Comparative Example 3 in which the number of times of charge and discharge is 1, and Comparative Example 4 in which charge and discharge were not performed, the FSN-containing film was formed non-uniformly on the surface of the electrode. Therefore, the peak intensity ratio I₁/I₂ was smaller than 1.5. Even if the charge-discharge conditions are appropriate, in Comparative Example 5 in which the molar ratio of FSI anions was small, the intensity of the second peak was increased. Therefore, the peak intensity ratio I₁/I₂ was smaller than 1.5.

The electrode according to at least one embodiment or Examples described above includes an electrode layer including at least one of a Li metal or a Li alloy, and a film containing F, S, and N. Furthermore, the electrode satisfies the following formula (1):

$$1.5 \leq {I}_{1} / {I}_{2} . \qquad ( 1 )$$

In the formula (1), I₁ is an intensity of a first peak that appears in a range of 686 eV or more and 690 eV or less of the F1s spectrum obtained by XPS. I₂ is an intensity of a second peak that appears in a range of 683 eV or more and 685 eV or less of the F1s spectrum obtained by XPS.

According to the electrode, the charge-discharge cycle life can be improved.

Inventions which can be derived from the embodiments include the following.
<1> An electrode comprising:
an electrode layer including at least one of a Li metal or a Li alloy; and
a film covering at least a part of a surface of the electrode layer and comprising F, S, and N,
the electrode satisfying the following formula (1):

$$1.5 \leq {I}_{1} / {I}_{2} \qquad ( 1 )$$

where I₁ is an intensity of a first peak that appears in a range of 686 eV or more and 690 eV or less of an F1s spectrum obtained by X-ray photoelectron spectroscopy, and I₂ is an intensity of a second peak that appears in a range of 683 eV or more and 685 eV or less of the F1s spectrum.
<2> The electrode according to <1>, wherein an intensity ratio represented by I₁/I₂ is 1.5 or more and 15 or less.
<3> The electrode according to <1> or <2>, wherein the first peak derives from at least one of a C—F bond or a SO₂—F bond, and the second peak derives from a Li—F bond.
<4> The electrode according to any one of <1> to <3>, wherein the film further comprises at least one selected from the group consisting of a C—F bond, a SO₂—F bond, and a Li—F bond.
<5> The electrode according to any one of <1> to <3>, wherein the film further comprises at least one of a C—F bond or a SO₂—F bond, and a Li—F bond.
<6> The electrode according to any one of <1> to <3>, wherein the film further comprises an organic component including at least one of a C—F bond or a SO₂—F bond, and an inorganic component including a Li—F bond.
<7> The electrode according to any one of <1> to <6>, wherein the film further comprises at least one type of atom selected from the group consisting of Li, C, O, Si, and Cl.
<8> A secondary battery including a positive electrode, a negative electrode, and an electrolyte, wherein
the negative electrode is the electrode according to any one of <1> to <7>.
<9> The secondary battery according to <8>, wherein the electrolyte includes sulfonium cations and anions including at least one of [N(FSO₂)₂]⁻ or [N(CF₃SO₂)₂]⁻.
<10>. The secondary battery according to <9>, wherein a molar ratio of [N(FSO₂)]⁻ to a total of [N(FSO₂)₂]⁻ and [N(CF₃SO₂)₂]⁻ is 0.3 or more and 0.6 or less.
<11> A battery pack comprising the secondary battery according to any one of <1> to <10>.
<12> The battery pack according to <11>, further comprising:
an external power distribution terminal; and
a protective circuit.
<13> The battery pack according to <11> or <12>, comprising a plurality of the secondary batteries,
wherein the secondary batteries are electrically connected in series, in parallel, or in a combination of series and parallel.
<14> A vehicle comprising the battery pack according to any one of <11> to <13>.
<15> A stationary power supply comprising the battery pack according to any one of <11> to <13>.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electrode comprising:
an electrode layer including at least one of a Li metal or a Li alloy; and
a film covering at least a part of a surface of the electrode layer and comprising F, S, and N,
the electrode satisfying the following formula (1):
$$1.5 \leq {I}_{1} / {I}_{2} \qquad ( 1 )$$
where I₁ is an intensity of a first peak that appears in a range of 686 eV or more and 690 eV or less of an F1s spectrum obtained by X-ray photoelectron spectroscopy, and I₂ is an intensity of a second peak that appears in a range of 683 eV or more and 685 eV or less of the F1s spectrum.

2. The electrode according to claim 1, wherein an intensity ratio represented by I₁/I₂ is 1.5 or more and 15 or less.

3. The electrode according to claim 1, wherein the first peak derives from at least one of a C—F bond or a SO₂—F bond, and the second peak derives from a Li—F bond.

4. The electrode according to claim 1, wherein the film further comprises at least one selected from the group consisting of a C—F bond, a SO₂—F bond, and a Li—F bond.

5. The electrode according to claim 1, wherein the film further comprises a Li—F bond and at least one of a C—F bond or a SO₂—F bond.

6. The electrode according to claim 1, wherein the film further comprises an organic component including at least one of a C—F bond or a SO₂—F bond, and an inorganic component including a Li—F bond.

7. The electrode according to claim 1, wherein the film further comprises at least one type of atom selected from the group consisting of Li, C, O, Si, and Cl.

8. A secondary battery including a positive electrode, a negative electrode, and an electrolyte, wherein
the negative electrode is the electrode according to claim 1.

9. The secondary battery according to claim 8, wherein the electrolyte includes sulfonium cations and anions including at least one of [N(FSO₂)₂]⁻ or [N(CF₃SO₂)₂]⁻.

10. The secondary battery according to claim 9, wherein a molar ratio of [N(FSO₂)₂]⁻ to a total of [N(FSO₂)₂]⁻ and [N(CF₃SO₂)₂]⁻ is 0.3 or more and 0.6 or less.

11. A battery pack comprising the secondary battery according to claim 8.

12. The battery pack according to claim 11, further comprising:
an external power distribution terminal; and
a protective circuit.

13. The battery pack according to claim 11, comprising a plurality of the secondary battery,
wherein the secondary batteries are electrically connected in series, in parallel, or in a combination of series and parallel.
